(19) United States
(12) Patent Application Publication
(10) Pub. No.: US 2012/0227995 A1
(43) Pub. Date: Sep. 13, 2012

(54) Connecting Rod Drive Comprising an Additional Oscillator

(75) Inventors: Carsten Diem, Ludwigsburg (DE); Willy Braun, Neustetten (DE); Hardy Schmid, Stuttgart (DE); Holger Ruebsaamen, Stuttgart (DE); Jan Koalick, Leinfelden (DE); Peter Loehnert, Moessingen (DE)

(73) Assignee: Robert Bosch GmbH, Stuttgart (DE)

(21) Appl. No.: 13/497,052

(22) PCT Filed: Jul. 27, 2010
(86) PCT No.: PCT/EP10/60848

§ 371 Date: Jun. 4, 2012

(30) Foreign Application Priority Data
Sep. 24, 2009 (DE) 102009044934.5

(51) Int. Cl. B25D 17/24

(52) U.S. Cl. 173/162.2

(57) ABSTRACT

An electric tool includes a striking mechanism assembly, which can be driven in and against a striking direction in a cyclic manner, and a counter-oscillator for compensating for vibrations of the electric tool, in particular of housing oscillations, comprising a balancing mass. The balancing mass can be driven in a movement direction by driving the striking mechanism assembly, wherein the movement direction extends at an angle to the striking direction.

### PRIOR ART

The present invention relates to a counter-oscillator which is provided in an electric tool for compensating the housing vibrations of said electric tool which comprises, in particular, a percussion mechanism subassembly, which counter-oscillator comprises a drive means and a compensating mass.

As a result of the implementation of the statutory requirement, when electric tools are used, to couple the permissible daily workload to the physical load acting upon the operator, the topic of vibrations is becoming increasingly important in electric tools, above all in hammer drills and percussion hammers.

The percussion drilling and chipping of a hammer involve major physical load upon the operator arising from the housing oscillation generated by the percussion mechanism. Precisely in the case of large hammer drills and percussion hammers, vibrations are very pronounced because of the high beating energy. For operators of such machines, therefore, the permitted work time is sometimes reduced considerably without any further measures. Consequently, development is increasingly concentrated on solutions in which the vibrations of electric tools are reduced. It can thereby be ensured that work can also continue to be carried out unrestrictedly with these appliances.

It is known that a typical housing oscillation of hammer drills and percussion hammers which have a percussion mechanism subassembly in which a piston is driven by an eccentric drive is composed of a plurality of frequency components. Housing oscillations are caused, for example, by air forces from the pneumatic percussion mechanism, mass forces of the connecting rod/piston drive and reactions of the inserted tool.

Since nonlinear systems act with movement sequences which are harmonic to only a limited extent, the individual vibration components are superposed on one another in a complex way. Play between the individual structure parts, by nonlinear elasticity profiles, by nonlinear impact actions and by only approximately harmonic reaction forces from the percussion mechanism give rise to unharmonic housing oscillations of complex order.

Since the structural parts of the electric tool act in various directions of space, moreover, the vibration-generating oscillations are composed of oscillation components from all directions of space.

In practice, the generation of counterforces takes place, for example, by means of a counter-oscillator which counteracts the housing vibrations. In the counter-oscillator, a compensating mass is coupled to the drive of the electric tool and is driven such that the reaction force resulting from the drive of the counter-oscillator counteracts the vibration source as effectively as possible.

Known drive concepts for the compensating mass of a counter-oscillator can be divided into two classes: in the first case, the compensating mass is positively driven by means of an eccentric crank or Scotch-yoke chain.

In the second case, the compensating mass is driven via cams, the necessary touch contact being provided by means of spring action upon the compensating mass. In this case, the compensating mass is not positively driven.

Examples of a positively driven compensating mass are shown in publications EP 1 475 190 A2 and EP 1 439 038 A1. In EP 1 475 190 A2, the compensating mass is arranged around the hammer tube and is driven by an additional connecting rod linked to the percussion mechanism eccentric. In EP 1 439 038 A1, a parallelepipedal compensating mass provided with a cross slot is arranged above the eccentric. A bolt, eccentric with respect to the axis of rotation, of the percussion mechanism eccentric runs in the cross slot, so that the compensating mass is driven via a Scotch yoke.

An example of a screw-loaded compensating mass is shown in publication WO 2004/082897 A1. So that, in this embodiment, the compensating mass can follow the cam geometry, considerable pressure forces have to be applied to the compensating mass via the elastic spring elements. This not only necessitates additional outlay, construction space and costs. But also, frictional and wearing effects are intensified by the additional spring pressure, and moreover a large part of the energy required for compressing the spring is lost, so that the overall efficiency is impaired and more motor power has to be made available.

What the embodiments known hitherto have in common is that they primarily damp the housing oscillation caused by the percussion mechanism subassembly. Frequency components from further vibration sources, for example as a result of an appliance center of gravity which leads to housing oscillations which do not act in the beating direction, cannot be sufficiently compensated by means of the embodiments known hitherto.

### DISCLOSURE OF THE INVENTION

The object of the invention, therefore, is to provide an electric tool comprising a counter-oscillator, by means of which the housing oscillation of the electric tool can be compensated more effectively and, in particular, by means of which vibrations from other vibration sources can also be compensated in addition to the vibrations caused by a percussion mechanism subassembly.

The object is achieved by means of an electric tool with a percussion mechanism subassembly which can be driven cyclically in and opposite to a beating direction, and with a counter-oscillator for the compensation of vibrations of the electric tool, in particular of housing oscillations, which counter-oscillator comprises a compensating mass, the compensating mass being drivable in a direction of movement by means of the drive of the percussion mechanism subassembly, the direction of movement extending at an angle to the beating direction.

A vibration-generating oscillation can be counteracted in that a counter-oscillation of the same amount is generated in the opposite direction.

There is provision, according to the invention, of the direction of movement to extend at an angle to the beating direction. As a result, the direction of movement of the compensating mass is adapted more effectively to the direction of the vibration-generating oscillations in the electric tool. This is because not only vibration-generating oscillations in the beating direction are active in the electric tool, but also further vibration sources cause oscillations which act at an angle to the beating direction. Such oscillations arise, for example, from the center of gravity of the electric tool. Since the angle at which the compensating mass moves corresponds essentially to the direction of movement opposite which the sum of vibration-generating oscillations acts, these can be at least partially compensated.

In the electric tool according to the invention, therefore, not only vibration-generating oscillations acting in the beating direction can be compensated, but also further vibration-generating oscillations acting at an angle to the beating direction, for example those caused by impact or recoil actions of a beating chain, by play between structural parts, by nonlinear elasticity profiles, by only approximately harmonic reaction forces of the percussion mechanism or by uncompensated mass forces of the drive.

Preferably, the electric tool has an eccentric disk which is rotatable concentrically about an eccentric axis in a direction of rotation, the direction of movement of the compensating mass having a first movement component which extends in the direction of the eccentric axis. It is known to a person skilled in the art that a direction of movement is formed from a sum of movement components which extend parallel to the coordinates of a Cartesian coordinate system. This embodiment therefore makes it possible to compensate vibration-generating oscillations which extend in the direction of the eccentric axis.

Preferably, furthermore, the direction of movement has a second movement component in the beating direction and/or a third movement component transverse to the beating direction and transverse to the direction of the eccentric axis. Vibration-generating oscillations which act in at least two or in all three directions of space can therefore be compensated.

In a preferred embodiment, the direction of movement changes during the drive of the percussion mechanism subassembly. By means of such an embodiment, it is possible to compensate varying loads. For example, the center of gravity of the electric tool, also called the instantaneous center of rotation, changes during its use. The vibration-generating oscillation, in particular its direction, is varied as a result. Such varying vibration-generating oscillations can be at least partially compensated by adapting the direction of movement.

The counter-oscillator preferably comprises a drive means for driving the compensating mass, which drive means is provided to be rotatable eccentrically about the eccentric axis. Such a drive means can be provided simply and cost-effectively on the eccentric disk.

In a preferred embodiment, the drive means is an eccentric pin on which a connecting rod for driving the percussion mechanism subassembly is arranged. A structural part already required for driving the percussion mechanism subassembly is therefore also used for driving the counter-oscillator.

In a preferred embodiment, by the drive means being rotated about the drive axis, the compensating mass can be moved to and fro from an initial point essentially in the direction of movement and returns to the initial point. The compensating mass is therefore moved cyclically to and fro by the drive means.

The compensating mass is preferably positively driven. As a result, the transmission of movement between the drive means and the compensating mass is unequivocal even in the case of high reaction forces and a high operating frequency. Moreover, no additional pressure means, such as, for example, springs are required, so that the outlay, construction space and cost are reduced, as compared with embodiments of counter-oscillators which are not positively driven. Moreover, energy required for the pressure force or on account of friction and additional wearing effects does not have to be made available by the motor power.

In a preferred embodiment, the counter-oscillator comprises a drive disk which cooperates with the drive means, the drive disk being rotatable about a drive axis as a result of the drive of the percussion mechanism subassembly. As a result, the rotational movement of the drive means is converted into a rotational movement of the drive disk. In this case, the drive axis preferably extends parallel to the eccentric axis. Embodiments are also possible, however, in which the drive axis extends at a second angle to the eccentric axis. In this case, the second angle is the same angle as or an angle other than the angle of the direction of movement to the beating direction.

In this embodiment, the compensating mass is preferably arranged on a push rod which is arranged eccentrically on the drive disk and cooperates with the compensating mass, so that, by the drive disk being driven about the drive axis, the compensating masses can be moved in translational motion. In this embodiment, the angle of the direction of movement to the beating direction is constant. Furthermore, the translational movement of the compensating mass preferably takes place cyclically to and fro.

In a further preferred embodiment, the counter-oscillator comprises a link block into which the drive means engages, the link block being movable to and fro in translational motion by means of the drive of the percussion mechanism subassembly. The rotational movement of the drive means is thereby converted into translational movement. The link block preferably moves in and opposite to the beating direction, especially preferably cyclically. Embodiments are also possible, however, in which the link block moves at a third angle to the beating direction. In this case, the third angle is the same angle as or an angle other than the angle of the direction of movement to the beating direction.

In this embodiment, the compensating mass is preferably arranged on a pivoting oscillator which is mounted pivotably about a pivot axis and cooperates with the link block, so that the compensating mass can be pivoted about the pivot axis by means of the drive of the link block. Since the compensating mass is pivoted about a pivot axis, in particular is pivoted cyclically to and fro, the direction of movement of the compensating mass changes during the drive of the percussion mechanism subassembly.

Preferably, the counter-oscillator is arranged in a cover subassembly of the electric tool. The electric tool can consequently be retrofitted with a counter-oscillator according to the invention. Or it is possible to exchange the counter-oscillator, for example in order to adapt the electric tool to different operating modes.

An electric tool according to the invention is, for example, a percussion hammer or a hammer drill.

The invention is described below by means of figures. The figures are merely by way of example and do not restrict the general idea of the invention.

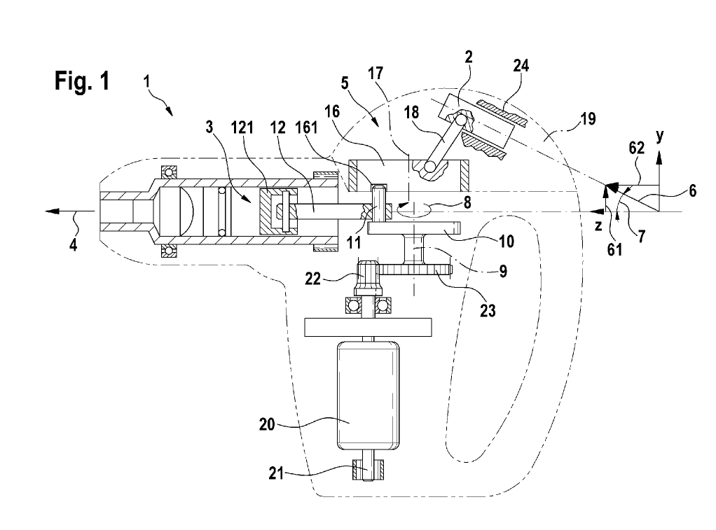

FIG. 1 shows an embodiment of an electric tool according to the invention,

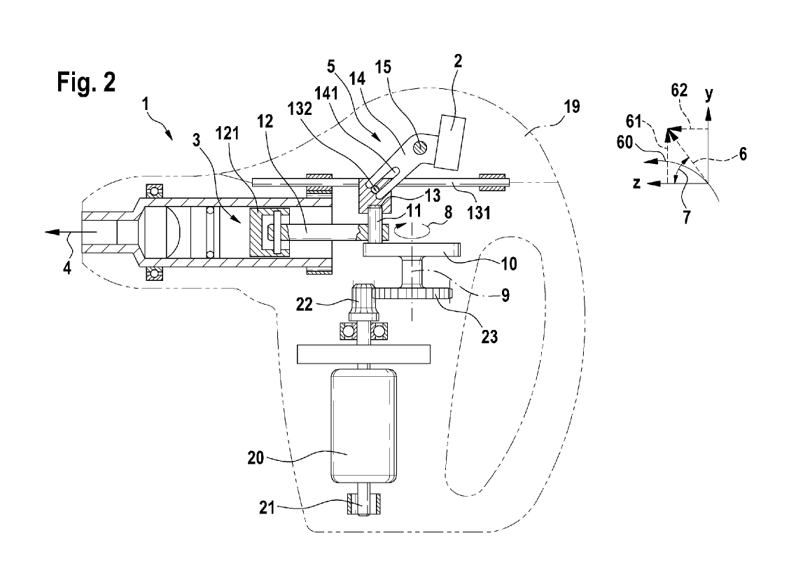

FIG. 2 shows a further embodiment of an electric tool according to the invention, and

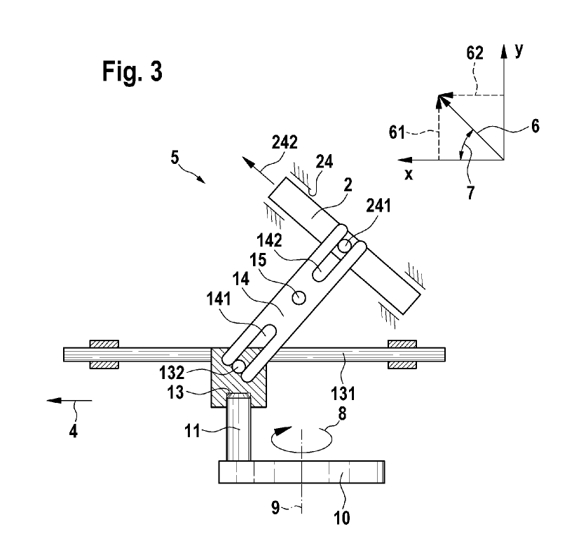

FIG. 3 shows a detail of a further embodiment of an electric tool according to the invention.

FIG. 1 shows an embodiment of an electric tool 1 according to the invention. In the present case, the electric tool 1 is a hammer drill.

The electric tool 1 is driven by means of an electric motor 20, the electric motor 20 driving a motor shaft 21 by means of a drive pinion 22, and the drive pinion driving a drive wheel 23 which is concentrically arranged rotatably about an eccentric axis 9 in a direction of rotation 8. Furthermore, an eccentric disk 10 is concentrically arranged rotatably about the eccentric axis 9, so that the eccentric disk 10 is driven by the drive of the drive wheel 23.

A connecting rod 12 is eccentrically arranged rotatably about the eccentric axis 33 on the eccentric disk 10 by means of an eccentric pin 11. The rotational movement of the eccentric disk 10 is converted via the connecting rod 12 into a translational movement, in order to drive a piston 121 of a percussion mechanism subassembly 3, arranged on the connecting rod 12, cyclically in or opposite to a beating direction 4.

The electric tool 1 has a counter-oscillator 5 which is arranged in a cover subassembly 19 of the electric tool 1. The counter-oscillator 5 is driven by a drive means 11 which is formed here by the eccentric pin 11. The terms “drive means 11” and “eccentric pin 11” are therefore used synonymously below. The eccentric pin 11 engages into a recess 161 of a drive disk 16 of the counter-oscillator 5. The drive disk 16 is arranged essentially parallel to the eccentric disk 10 and is mounted rotatably about a drive axis 17. In the embodiment illustrated here, the drive axis 17 extends essentially parallel to the eccentric axis 9.

The counter-oscillator 5 has a compensating mass 2 which is displaceable in a direction of movement 6 along a guide means 24 which is arranged in the cover subassembly 19. A suitable guide means 24 is, for example, a link block.

The compensating mass 2 is arranged on a push rod 18 and, in particular, cylindrically rotatably in the link block 24. The push rod 18, furthermore, is arranged eccentrically on the drive disk 16, in particular by means of a ball joint. During the drive of the drive disk 16, the rotational movement of the drive disk 16 is therefore converted into a translational pushing movement of the compensating mass 2 in the direction of movement 6.

The direction of movement 6 runs at an angle 7 to the beating direction 4. It can be broken down in a cartesian coordinate system x, y, z into a first movement component 61, here in the y-direction of the coordinate system which runs parallel to the eccentric axis 9, and a second movement component 62, here in the z-direction of the coordinate system which runs parallel to the beating direction 4. Since the direction of movement 6 of the compensating mass 2 is formed not only from a movement component 62 extending parallel to the beating direction 4, but also from a movement component 61 extending transversely to the beating direction 4, even vibration-generating oscillations which do not act in the beating direction can be compensated by means of this counter-oscillator 5.

It is also possible to have electric tools 1 with counter-oscillators 5 in which the direction of movement 6 of the compensating mass 2 has a third movement component (not shown here) which extends in the third direction of space, here the x-direction of a cartesian coordinate system.

FIG. 2 shows a further embodiment of an electric tool 1 according to the invention. As compared with the embodiment of FIG. 1, the embodiment has a different counter-oscillator 5 which, however, is likewise arranged in the cover subassembly 19.

The counter-oscillator 5 of this embodiment likewise has as drive means 11 the eccentric pin 11, by means of which the connecting rod 12 for driving the piston 121 in the beating direction 4 is arranged on the eccentric disk 10. Here too, therefore, the terms “eccentric pin 11” and “drive means 11” are used synonymously. Here, however, a link block 13 is provided, into which the eccentric pin 11 engages and which is connected rigidly to a sliding rod 131 which is arranged in the cover subassembly 19 displaceably essentially in the beating direction 4. During the rotation of the eccentric pin eccentrically about the eccentric axis 9, the sliding rod 131 is moved to and fro cyclically essentially in the beating direction 4.

The compensating mass 2 is arranged on a pivoting oscillator 14 which is mounted in the cover subassembly rotatably about a pivot axis 15. The pivoting oscillator 14 has a jaw opening 141 into which engages a bolt 132 which is arranged on the link block 13. Embodiments are also possible, however, in which the bolt 132 is arranged on the sliding rod 131.

During the displacement of the sliding rod 131 in the beating direction 4, the pivoting oscillator 14 is pivoted about the pivot axis 15. The compensating mass 2 is thereby also pivoted concentrically about the pivot axis 15. When the sliding rod 131 is pushed back opposite to the beating direction 4, the pivoting oscillator 14 is pivoted back about the pivot axis 15, so that the compensating mass 2 is also pivoted back. The compensating mass 2 is therefore pivoted cyclically to and fro in this embodiment.

Since the compensating mass 2 is pivoted about the pivot axis 15, the direction of movement 6 of the compensating mass 2 changes during the drive of the counter-oscillator 5. This is because the compensating mass pivots to and fro concentrically about the pivot axis 15 along a circular path 60. The direction of movement 6 can be found at any moment by drawing a tangent to the circular path 60. As shown in FIG. 2, here too, the direction of movement 6 is composed of a first movement component 61 parallel to the eccentric axis 9 and of a second movement component 62 parallel to the beating direction 4.

Here too, embodiments may be envisaged, however, in which the direction of movement 6 also has a third movement component (not shown here) in the third direction of space, here the x-direction of the cartesian coordinate system.

By means of this embodiment, even vibration-generating oscillations, the direction of action of which changes during the operation of the electric tool 1, can be compensated.

FIG. 3 shows a detail of a further embodiment of an electric tool 1 according to the invention with a counter-oscillator 5. Similarly to the embodiment of FIG. 2, the compensating mass 2 of this counter-oscillator 5 is arranged on a pivoting oscillator 14 which is mounted rotatably about a pivot axis 15. The pivoting oscillator 14 likewise has the jaw opening 141 into which engages the bolt 132 which is arranged on the link block 13 which is connected rigidly to the sliding rod 131 driveable by means of the eccentric pin 11.

However, this pivoting oscillator 14 has a second jaw opening 142 into which engages a second bolt 241 which is arranged on the mass 2. The mass 2 is mounted in a link block 24, for example, of a housing of the electric tool 1 (see FIGS. 1 and 2). The link block 24 extends essentially in a link direction 242. During the drive of the eccentric pin 11 about the eccentric axis 9, the sliding rod 131 is moved to and fro in the beating direction 4. In this case, the pivoting oscillator 14 is pivoted to and fro about the pivot axis 15.

The compensating mass 2 is thereby moved to and fro in the direction of movement 6 which extends in the link direction 242.

If the link direction 242 is arranged at an angle 7 to the beating direction 4, the direction of movement 6 is again composed of a first movement component 61 parallel to the eccentric axis 9 and of a second movement component 62 parallel to the beating direction 4, so that by means of this embodiment too, vibration-generating oscillations which do not act in the beating direction 4 can be compensated by means of this counter-oscillator 5 in a similar way to the embodiment of FIG. 1.

In this embodiment, too, it is conceivable that the direction of movement 6 has a third movement component (not shown here) in the third direction of space, here the x-direction of the cartesian coordinate system.

Embodiments may also be envisaged in which, instead of the eccentric pin 11 as the drive means 11, a pin (not shown here) spaced apart from the eccentric pin 11 is used as the drive means 11. Furthermore, it is also conceivable to use, instead of the eccentric disk 10, another drive disk (not shown here) for driving the drive means 11.

In the electric tool 1 according to the invention, the compensating mass 2 moving at an angle 7 to the beating direction 4 makes it possible not only to compensate oscillations caused by the percussion mechanism subassembly 3, but also to compensate further vibration-generating oscillations caused by vibration sources which do not act in the beating direction 4.

1. An electric tool, comprising:
a percussion mechanism subassembly configured to be driven cyclically in and opposite to a beating direction, and
a counter-oscillator configured to compensate for vibrations of the electric tool, the counter-oscillator comprising a compensating mass configured to be driven in a direction of movement by the drive of the percussion mechanism subassembly,
wherein the direction of movement extends at an angle to the beating direction.

2. The electric tool as claimed in claim 1, further comprising an eccentric disk which is rotatable concentrically about an eccentric axis in a direction of rotation, the direction of movement of the compensating mass having a first movement component which extends in the direction of the eccentric axis.

3. The electric tool as claimed in claim 2, wherein the direction of movement has a second movement component in the beating direction and/or a third movement component transverse to the beating direction and transverse to the direction of the eccentric axis.

4. The electric tool as claimed in one of the preceding claims claim 1, wherein the direction of movement changes during the drive of the percussion mechanism subassembly.

5. The electric tool as claimed in claim 1, wherein:
the counter-oscillator comprises a drive mechanism configured to drive the compensating mass, and
the drive mechanism is configured to be rotatable eccentrically about the eccentric axis.

6. The electric tool as claimed in claim 1, further comprising a connecting rod configured to drive the percussion mechanism subassembly, wherein the drive mechanism includes an eccentric pin on which the connecting rod is arranged.

7. The electric tool as claimed in claim 1, wherein the compensating mass is configured to be positively driven.

8. The electric tool as claimed in claim 1, wherein the counter-oscillator comprises a link block into which the drive mechanism engages, the link block being movable to and fro in translational motion by the drive of the percussion mechanism subassembly.

9. The electric tool as claimed in claim 8, further comprising a pivoting oscillator which is mounted rotatably about a pivot axis, wherein the compensating mass is arranged on the pivoting oscillator and is configured to cooperate with the link block, so that the compensating mass is pivotable about the pivot axis by the drive of the link block.

10. The electric tool as claimed in claim 1, wherein the counter-oscillator comprises a drive disk which is configured to cooperate with the drive mechanism, the drive disk being rotatable about a drive axis by the drive of the percussion mechanism subassembly.

11. The electric tool as claimed in claim 10, further comprising a push rod which is arranged eccentrically on the drive disk, wherein:
the compensating mass is arranged on the push rod, and
the push rod is configured to cooperate with the compensating mass so that the compensating mass is movable in translational motion by the drive of the drive disk about the drive axis.

12. The electric tool as claimed in claim 1, further comprising a cover subassembly, wherein the counter-oscillator is arranged in the cover subassembly.
